(19) United States
(12) Patent Application Publication
(10) Pub. No.: US 2026/0321161 A1
(43) Pub. Date: Oct. 15, 2026

(54) COMMUNICATION DEVICE, INFORMATION PROCESSING APPARATUS, CONTROL METHOD THEREOF, AND STORAGE MEDIUM

(71) Applicant: HONDA MOTOR CO., LTD., Tokyo (JP)

(72) Inventor: Yuji NISHIKAWA, Tokyo (JP)

(21) Appl. No.: 19/678,951

(22) Filed: May 15, 2026

Related U.S. Application Data
(63) Continuation of application No. PCT/JP2023/043645, filed on Dec. 6, 2023.

(51) Int. Cl. G09B 29/10; G09B 29/00

(52) U.S. Cl. CPC G09B 29/106; G09B 29/001

(57) ABSTRACT

A communication device, comprising a control unit configured to display a map including a touring course, and also display a display form indicating one or more predetermined points of the touring course, and display video information corresponding to the touring course, and also display a display form indicating one or more reproduction positions of a video, the one or more reproduction positions corresponding to the one or more predetermined points.

### CROSS-REFERENCE TO RELATED APPLICATIONS

This application is a continuation of International Patent Application No. PCT/JP2023/043645 filed on Dec. 6, 2023, the entire disclosures of which are incorporated herein by reference.

### BACKGROUND OF THE INVENTION

### Field of the Invention

The present invention relates to a communication device, an information processing apparatus, a control method thereof, and a storage medium.

### Description of the Related Art

PTL 1 discloses selecting a driving course preferred by a user from a plurality of driving courses registered beforehand in an on-vehicle device or the like.

### CITATION LIST

### Patent Literature

PTL 1: Japanese Patent Laid-Open No. 2002-221431

### SUMMARY OF INVENTION

### Technical Problem

In the technique described in PTL 1, however, there is a problem in that it is difficult for a user to easily confirm details of a desired touring course.

### SUMMARY OF THE INVENTION

The present invention has been made in view of the above problem, and provides a technique for allowing a user to easily confirm details of a touring course.

According to one aspect of the present invention, there is provided a communication device, comprising a control unit configured to display a map including a touring course, and also display a display form indicating one or more predetermined points of the touring course, and display video information corresponding to the touring course, and also display a display form indicating one or more reproduction positions of a video, the one or more reproduction positions corresponding to the one or more predetermined points.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a view for describing a configuration example of an information processing system according to one embodiment.

FIG. 2A is a block diagram for describing a configuration example of a plurality of information processing apparatuses (server apparatuses) according to one embodiment.

FIG. 2B is a block diagram for describing a configuration example of a communication device according to one embodiment.

FIG. 3A is a diagram illustrating a processing sequence of the information processing system according to a first embodiment.

FIG. 3B is a diagram illustrating the processing sequence of the information processing system according to the first embodiment.

FIG. 4 is a flowchart illustrating a procedure of processing performed by a communication device according to the first embodiment.

FIG. 5 is a view illustrating an example of a touring course and a thumbnail video on a display unit of the communication device according to the first embodiment.

FIG. 6 is a view illustrating an example of a touring course and a thumbnail video after movement and enlargement of a map on the display unit of the communication device according to the first embodiment.

FIG. 7 is a view illustrating an example of a touring course and a thumbnail video on the display unit of the communication device according to a modification of the first embodiment.

FIG. 8 is a diagram illustrating an example of position information of touring courses held by the information processing apparatus (the server apparatus) according to the first embodiment and specifying information for specifying a video related to each touring course.

FIG. 9A is a diagram illustrating a processing sequence of an information processing system according to a second embodiment.

FIG. 9B is a diagram illustrating a processing sequence of the information processing system according to the second embodiment.

FIG. 10A is a flowchart illustrating a procedure of processing performed by a communication device according to the second embodiment.

FIG. 10B is a flowchart illustrating the procedure of the processing performed by the communication device according to the second embodiment.

FIG. 11 is a view illustrating an example of displaying predetermined points of a touring course in association with reproduction positions of a video on a display unit of the communication device according to the second embodiment.

FIG. 12 is a view illustrating a display example for making it easy to recognize an advancing direction of a touring course in a video on a display unit of a communication device according to a modification of the second embodiment.

FIG. 13 is a view illustrating another display example for making it easy to recognize the advancing direction of the touring course in the video on the display unit of the communication device according to a modification of the second embodiment.

FIG. 14 is a view illustrating still another display example for making it easy to recognize the advancing direction of the touring course in the video on the display unit of the communication device according to a modification of the second embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

In the present embodiment, an example of enabling a user of a straddle type vehicle such as a motorcycle to efficiently search for, confirm, and select a touring course will be described.

### System Configuration

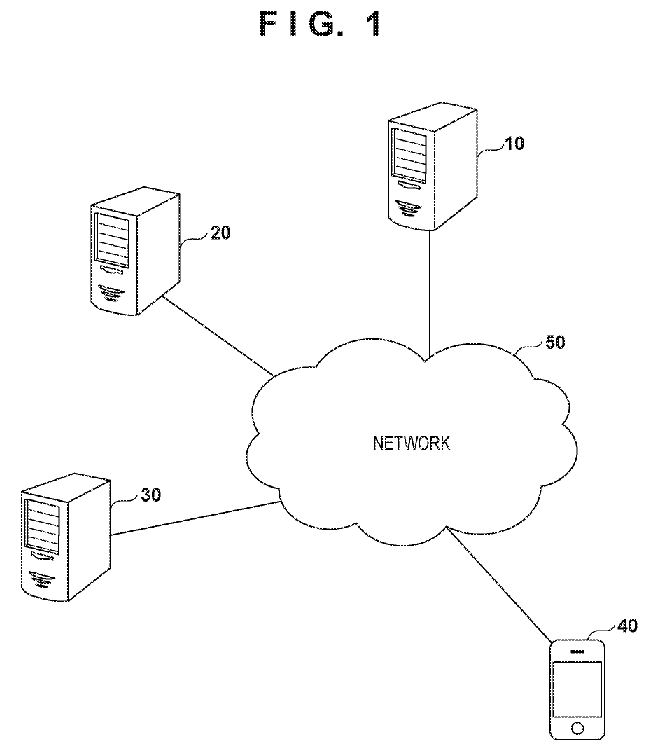

FIG. 1 is a view for describing a configuration of an information processing system according to one embodiment. The information processing system includes an information processing apparatus 10, an information processing apparatus 20, an information processing apparatus 30, and a communication device 40. They are configured to be communicable through a network 50. The network 50 is, for example, the Internet and/or a local area network (LAN).

The information processing apparatus 10 is a management server that manages position information of a touring course according to one embodiment and specifying information for specifying a video (for example, a URL or the like of the video) of the touring course. The information processing apparatus 20 is a video server apparatus that provides videos and video information according to one embodiment. The information processing apparatus 20 may be, for example, YouTube. Videos and video information posted on YouTube are available.

The information processing apparatus 30 is a map server apparatus that provides map information according to one embodiment. As a map, for example, Google MAP or the like is available in a case where the communication device 40 is Android, and Apple MAP is available in a case where the communication device 40 is an iPhone, but the map is not limited to them. The communication device 40 is a communication device according to one embodiment, and is, for example, a mobile information terminal (a smartphone, a tablet terminal, etc.) possessed by a user (for example, an occupant) of a vehicle such as a motorcycle. A touring information presentation application is installed in the communication device 40, and information about touring courses is provided for the user via such an application. In such a situation, advertisement information (advertising videos, advertising images) may be held beforehand in the information processing apparatus 10, and an advertisement may be displayed for the user when an application function is provided. Thus, the operator of the information processing apparatus 10 is capable of obtaining advertisement revenue.

In the information processing apparatus 10, the position information of the nationwide touring courses is registered and held beforehand, and one or more pieces of video information are held in association with each touring course. In addition, specifying information for specifying each video (for example, a URL of the video) is held.

In the information processing apparatus 10, the operator of the information processing apparatus 10 may directly contact a predetermined video content creator who posts a video of an attractive touring course, and ask them to create and post videos of various touring courses so that the users who use the touring information presentation application can browse the videos. In such a case, some consideration may be paid to the video content creator. In addition, the user who uses the touring information presentation application may be encouraged to purchase the information of the touring course (purchase one piece of the course information), and the purchase price may be partially returned to the video content creator. Alternatively, video content creators in general may be allowed to freely post videos of the touring courses via the touring information presentation application.

### Configuration of Information Processing Apparatus

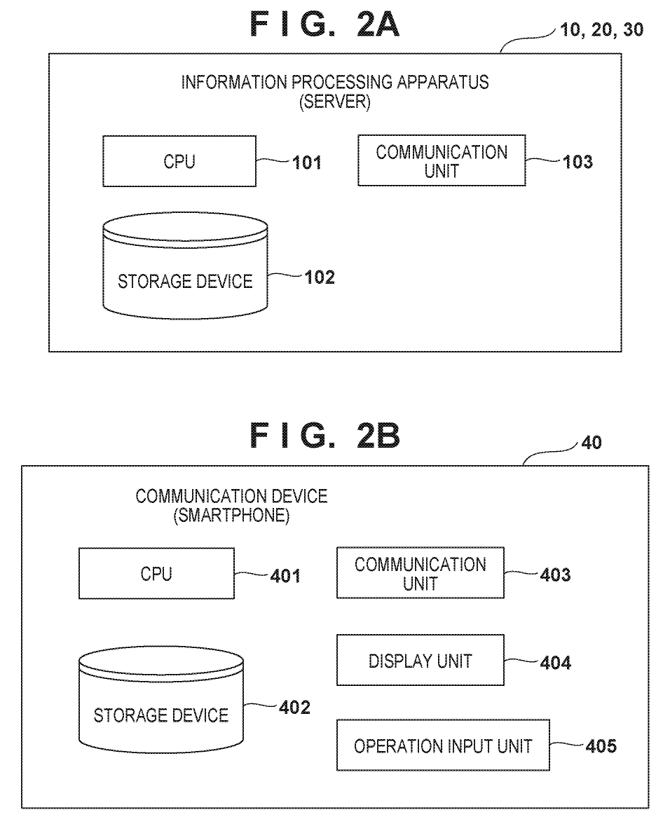

FIG. 2A is a diagram illustrating a configuration example of the information processing apparatuses 10, 20, and 30 according to one embodiment. The information processing apparatuses 10, 20, and 30 each include a CPU 101, a storage device 102, and a communication unit 103. The CPU 101 includes one or more CPUs, and performs processing by reading and executing a program stored in the storage device 102. The storage device 102 is a storage medium and/or a memory that stores various types of information. The storage device 102 is capable of storing a program to be read and executed by the CPU 101, and is also capable of storing information that has been acquired from another apparatus via the communication unit 103. The communication unit 103 communicates with another apparatus, and is capable of transmitting and receiving various types of information on wired or wireless communication.

### Configuration of Communication Device

FIG. 2B is a diagram illustrating a configuration example of the communication device 40 according to one embodiment. By using the application installed in the communication device 40, the user is able to browse, for example, the position information of the touring course for traveling on a motorcycle and the video information related to the touring course. The user is able to confirm and select a course that the user actually desires to go touring with reference to the information of the touring course that the user has browsed.

The communication device 40 includes a CPU 401, a storage device 402, a communication unit 403, a display unit 404, and an operation input unit 405. The CPU 401 includes one or more CPUs, and controls the operation of the communication device 40 by reading and executing a program stored in the storage device 402. The storage device 402 is a storage medium and/or a memory that stores a program to be read and executed by the CPU 401 and that also stores various types of information that has been input into the communication device 40 via the operation input unit 405.

The communication unit 403 communicates with the information processing apparatuses 10, 20, and 30, and is capable of transmitting and receiving various types of information on wired or wireless communication. The display unit 404 is a liquid crystal display or the like, and displays various types of information. The operation input unit 405 is a physical button, a touch input unit, a mouse, a keyboard, or the like, and the user is able to input various types of information by operating the operation input unit 405. In a case where the display unit 404 is a touch panel, the display unit 404 may also function as the operation input unit 405.

### Processing Sequence

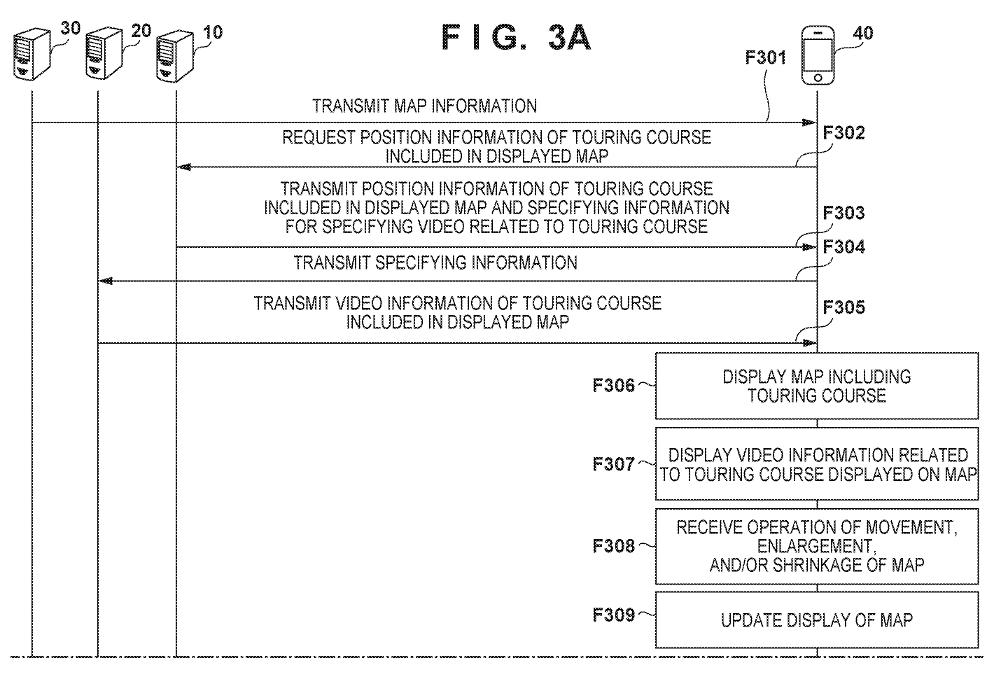

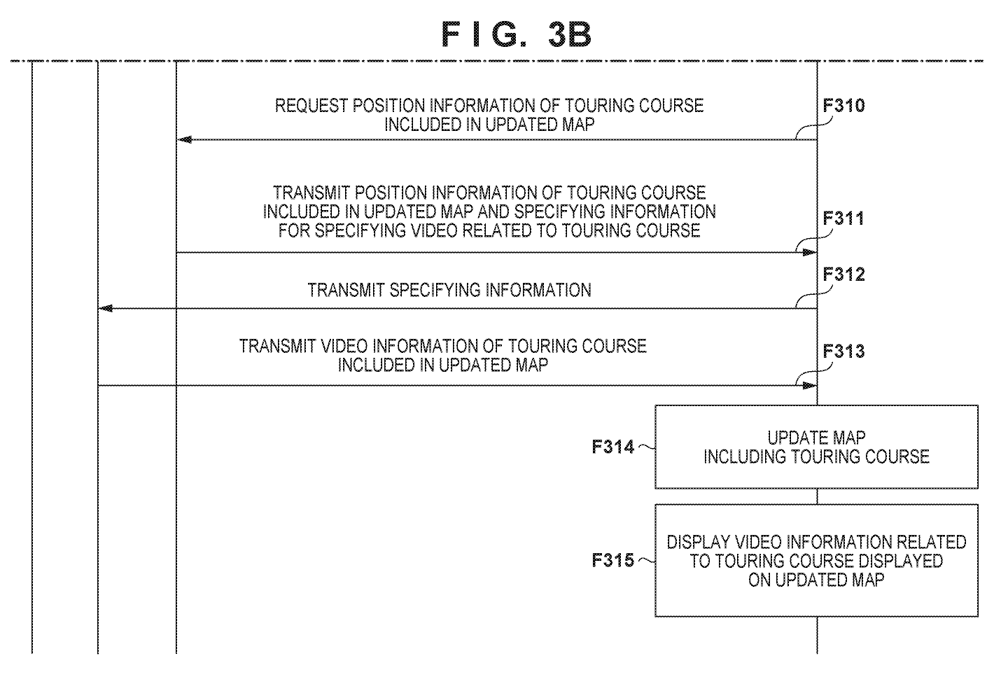

FIGS. 3A and 3B are diagrams each illustrating an example of a processing sequence in the information processing system according to the present embodiment. Such a processing sequence is performed, for example, when the user of the communication device 40 starts the touring information presentation application.

In F301, the information processing apparatus 30 transmits map information to the communication device 40. At the time of starting the application, for example, the nationwide map information of Japan may be transmitted, or map information of the last state when the application was previously used may be transmitted.

In F302, the communication device 40 requests the information processing apparatus 10 to provide the position information of the touring course included in the map that is currently displayed on the display unit 404.

In F303, in response to a request from the communication device 40, the information processing apparatus 10 transmits, to the communication device 40, the position information of the touring course included in the currently displayed map and the specifying information for specifying the video (for example, a URL or the like of the video) related to the touring course.

In F304, the communication device 40 transmits the specifying information that has been received from the information processing apparatus 10 to the information processing apparatus 20.

In F305, the information processing apparatus 20 transmits the video information of the touring course included in the map that is currently displayed on the display unit 404 of the communication device 40, based on the received specifying information. For example, in a case where the displayed map includes three touring courses A, B, and C, one or more pieces of video information A about the touring course A, one or more pieces of video information B about the touring course B, and one or more pieces of video information C about the touring course C are transmitted. The video information can include information such as a thumbnail video (a thumbnail image) of a video obtained by recording while actually traveling the touring course, a title and an explanatory note of the video, the number of views, a date of upload, and a channel name.

In F306, the communication device 40 displays a map including the touring course, based on the position information of the touring course that has been received from the information processing apparatus 10.

In F307, the communication device 40 displays the video information of the touring course that has been received from the information processing apparatus 20, as video information related to the touring course that is currently displayed on the map. This enables the user of the communication device 40 to easily confirm one or more touring courses included in the range of the currently displayed map and its video information.

In F308, the communication device 40 receives an operation of movement, enlargement, and/or shrinkage of the position on the map displayed on the display unit 404. For example, in a case where the display unit 404 is a touch panel, the user is able to perform a touch operation or a swipe operation to change the display position of the map or to enlarge or shrink the map. In a case where the display unit 404 is not a touch panel, the display position of the map may be changed or the map may be enlarged or shrunk by, for example, a mouse operation and/or a keyboard operation using the operation input unit 405.

In F309, the communication device 40 updates the display of the map on the display unit 404, based on various operations in F308. For example, in a case where the nationwide map information is acquired beforehand in F301, the display is updated using the map information held in the communication device 40. In addition, in a case where the nationwide map information is not acquired, a request for update information of the map may be transmitted to the information processing apparatus 30, and updated map information may be acquired from the information processing apparatus 30 and then displayed.

In F310, the communication device 40 requests the information processing apparatus 10 for the position information of the touring course included in the map updated in F309.

In F311, in response to a request from the communication device 40, the information processing apparatus 10 transmits, to the communication device 40, the position information of the touring course included in the updated map and the specifying information for specifying the video (for example, a URL or the like of the video) related to the touring course.

In F312, the communication device 40 transmits the specifying information that has been received from the information processing apparatus 10 to the information processing apparatus 20.

In F313, the information processing apparatus 20 transmits the video information of the touring course included in the updated map on the display unit 404 of the communication device 40, based on the received specifying information. For example, as a result of the operation in F308, in a case where the map is enlarged and the displayed map includes two touring courses, video information of each touring course is transmitted. For example, in a case where two touring courses A and B are included in the map, one or more pieces of video information A about the touring course A and one or more pieces of video information B about the touring course B are transmitted. Alternatively, as a result of the operation in F308, when the map is moved and two touring courses that are a touring course D and a touring course E are included in the displayed map, video information of each touring course is transmitted. In such a case, one or more pieces of video information D about the touring course D and one or more pieces of video information E about the touring course E are transmitted.

In F314, the communication device 40 updates and displays the map including the touring course, based on the position information of the touring course that has been received from the information processing apparatus 10.

In F315, the communication device 40 displays the video information of the touring course that has been received from the information processing apparatus 20 as video information related to the touring course displayed on the updated map. This enables the user of the communication device 40 to easily confirm one or more touring courses included in the range of the map that has been changed in response to a change of the display position of the map or enlargement or shrinkage of the map, and the video information. In particular, since the display content automatically changes in response to the operation on the map, the user is able to easily find the touring course in a desired region and its video information. Therefore, it becomes possible to easily confirm the touring course and select the touring course along which the user actually desires to travel.

Note that a series of processing steps of F308 through F315 is repeatedly performed in response to additional map operation. The above processing sequence of FIGS. 3A and 3B ends.

### Processing of Communication Device

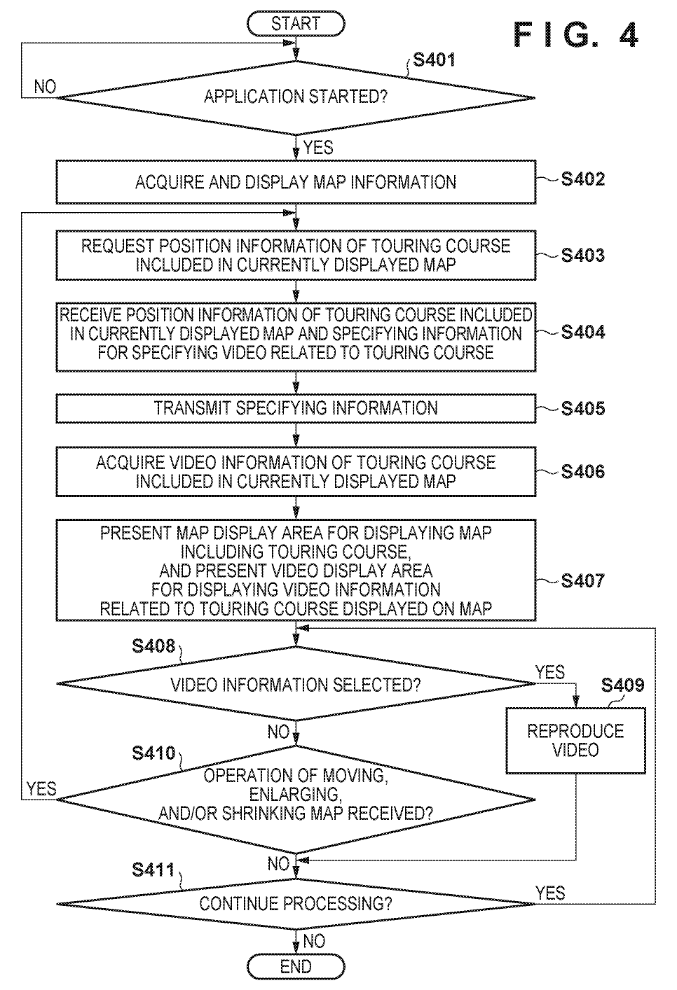

Next, FIG. 4 is a flowchart illustrating a procedure of processing performed by the communication device 40 according to the present embodiment. The present processing is performed by the CPU 401 of the communication device 40 reading and executing a program stored in the storage device 402.

In step S401, the CPU 401 determines whether the user has started the touring information presentation application of the communication device 40. In a case where Yes is determined in the present step, the processing proceeds to step S402. On the other hand, in a case where No is determined in the present step, the processing waits.

In step S402, the CPU 401 receives and acquires map information from the information processing apparatus 30, and displays the map information in a predetermined map display area. At the time of starting the application, for example, the nationwide map information of Japan may be received, or the map information of the last state when the application was previously used may be received. Note that in a case where the communication device 40 holds the nationwide map information beforehand, such processing may be skipped.

In step S403, the CPU 401 requests the information processing apparatus 10 to provide the position information of the touring course included in the map that is currently displayed on the display unit 404.

In step S404, the communication device 40 receives, from the information processing apparatus 10, the position information of the touring course included in the currently displayed map and the specifying information for specifying the video (for example, a URL or the like of the video) related to the touring course.

In step S405, the CPU 401 transmits the specifying information that has been received from the information processing apparatus 10 to the information processing apparatus 20.

In step S406, the CPU 401 receives, from the information processing apparatus 20, the video information of the touring course that is included in the map currently displayed on the display unit 404 of the communication device 40, and that has been specified, based on the specifying information.

In step S407, the CPU 401 presents a map display area for displaying a map including the touring course, based on the map information received in step S402 and the position information received in step S403. In the map display area, a map and a display form indicating the touring course included in the map are displayed. The display form of the touring course can be a thick line that follows the touring course and that is superimposed on the map. In addition, the CPU 401 presents a video display area for displaying the video information related to the touring course that is displayed on the map, based on the video information received in step S406. In the video display area, a thumbnail video or a thumbnail image, a title of the video, an explanatory note, the number of views, a date of upload, a channel name, and the like are displayed as one or more pieces of video information related to the touring course.

In step S408, the CPU 401 determines whether one of the one or more pieces of video information displayed in the video display area of the display unit 404 has been selected. For example, the video information may be selected in response to selection of the thumbnail video (or the thumbnail image) in the video information by a touch operation. In a case where the video information is selected, the processing proceeds to step S409. On the other hand, in a case where the video information is not selected, the processing proceeds to step S410.

In step S409, the CPU 401 reproduces the video corresponding to the video information selected in step S408. With regard to reproduction of the video, another screen may be launched, and then the video may be reproduced in the other screen. In a case where the reproduction of the video ends, the processing proceeds to step S411. Note that in a case where the reproduction of the video is interrupted on the way, the processing may transition to the state before step S408 starts.

In step S410, the CPU 401 determines whether an operation, by the user, of moving, enlarging, and/or shrinking the map has been received. In a case where the operation has been received, the processing returns to S403. On the other hand, in a case where the operation has not been received, the processing proceeds to step S411.

In step S411, the CPU 401 determines whether to continue the series of processing steps. For example, when the user ends the touring information presentation application, the processing ends. In a case where Yes is determined in the present step, the processing returns to S408. On the other hand, in a case where No is determined in the present step, the processing ends.

### Example of Screen Display

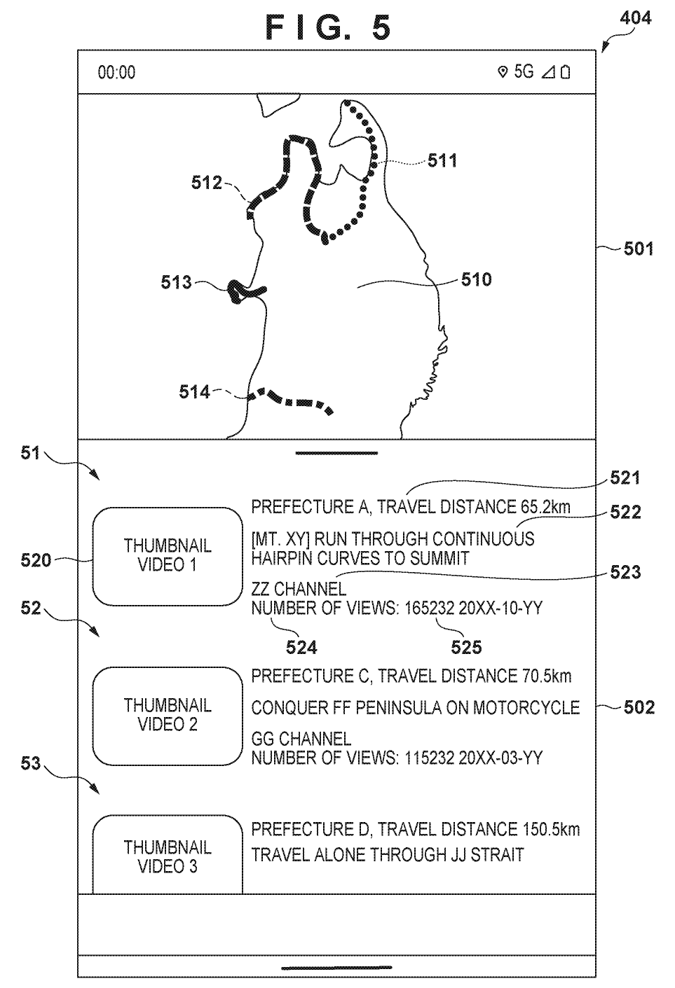

Subsequently, an example of a screen displayed on the display unit 404 of the communication device 40 in the processing of FIGS. 3A and 3B and the processing of FIG. 4 will be described with reference to FIG. 5. A map display area 501 and a video information display area 502 are displayed on the display unit 404.

In the map display area 501, a map 510 and display forms (a line 511 to a line 514) indicating the touring courses included in the currently displayed range of the map 510 are displayed. In the illustrated example, four touring courses are included in the map. In addition, the touring courses 511 to 514 are displayed so that they are distinguishable from one another in different types of thick lines. Note that a method for distinguishing the touring courses is not limited to the line types. The touring courses 511 to 514 may be displayed in different types of colors so that they are distinguishable from one another. In addition, instead of indicating the inside of the course in a single thick line, the periphery of the course may be surrounded by a thin line, and the inside may be distinguished by using a diagonal line, a vertical line, a horizontal line, a lattice pattern, or the like.

In the video display area 502, one or more pieces of video information 51, 52, 53, and so on are displayed. For example, the video information 51 can include at least one of a thumbnail video 1 (a thumbnail video 520), reference information 521 indicating the prefecture where a touring course in the video is located and the travel distance of such a touring course, a video title 522, a channel name 523, the number of views 524, and a date of upload (month day, year) 525. Note that these items are examples, and additional information may be included. For example, an explanatory note for describing the content of the video may be included.

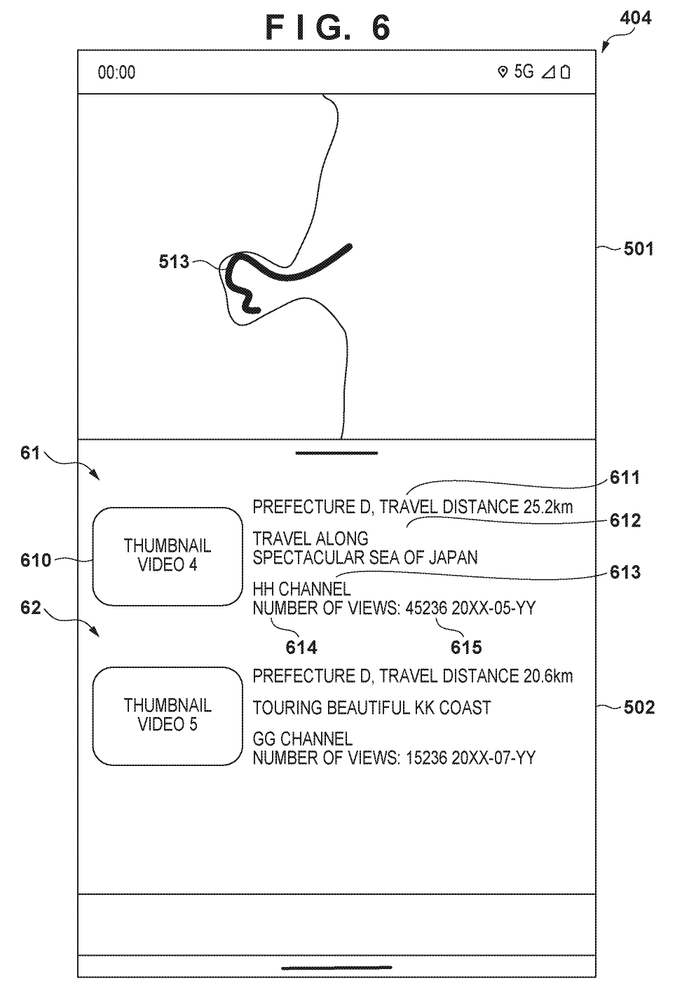

In the state of the display example of FIG. 5, when the user performs a touch operation and a swipe operation on the map display area 501 to move (change) the display position of the map and/or enlarge or shrink the map, the processing illustrated in FIGS. 3A and 3B and the processing of FIG. 4 are performed, and the map is updated. As a result, the touring course included in the map also changes. Furthermore, the display content of the video information also changes in accordance with the change in the touring course. For example, as a result that the user operates the map display area 501 and enlarges the map, it is assumed that the number of touring courses included in the map is changed to only one as illustrated in FIG. 6. In this case, only the video information related to such one touring course is displayed as the video information. In the example of FIG. 6, an operation of moving and enlarging the map is performed so that the map around the touring course 513 is displayed. As a result, the display content of the map display area 501 is updated, and a transition is made to include only one touring course 513 of four touring courses displayed in FIG. 5 in the map. In this situation, video information 61 and video information 62 related to the touring course 513 are displayed in the video information display area 502. In the illustrated example, there are only two pieces of video information. However, in a case where three or more videos are included in one touring course, still another piece of video information is displayed below the video information 62.

The video information 61 includes a thumbnail video 4 (a thumbnail video 610), reference information 611 indicating the prefecture where the touring course 513 in the video is located and the travel distance of the touring course 513, a video title 612, a channel name 613, the number of views 614, and a date of upload (month day, year) 615. Note that these items are examples, and some of them may not necessarily be included, or it may be configured to include additional information. For example, an explanatory note for describing the content of the video may be included.

Thus, by moving, enlarging, and/or shrinking the map to display a desired touring course in the map, the user is able to easily confirm the video information of such a desired touring course.

Note that as illustrated in FIGS. 5 and 6, in a case where there are a plurality of pieces of video information related to the touring course displayed on the map, such a plurality of pieces of video information are presented in the video display area 502 in an arrangement order based on predetermined information. Here, the predetermined information can include at least one of the number of views 524 and 614 of the video, the number of channel registrants of the video (not illustrated), the number of comments on the video (not illustrated), and a reproduction period of time indicating the length of the video (not illustrated). Here, the reproduction period of time is a length of one video itself (the time needed from the start of reproducing the video to its end, and for example, 10 minutes, 20 minutes, or the like).

In a case where the predetermined information is at least one of the number of views of the video, the number of channel registrants, and the number of comments on the video, the plurality of pieces of video information are presented in descending order. In the examples of FIGS. 5 and 6, control is conducted in such a manner that, as the number of views of the video increases, the video is displayed to be closer to the top. Priority orders may be given to these pieces of information beforehand. For example, it is assumed that the priority order 1 is the number of views, the priority order 2 is the number of channel registrants, and the priority order 3 is the number of comments on the video. In such a case, in a case where two videos have the same number of views, which is the priority order 1, or the difference is smaller than a predetermined value (or smaller than a predetermined ratio), the two videos may be displayed in descending order of the number of channel registrants, which is the priority order 2. Similarly, in a case where two videos have the same number of channel registrants, which is the priority order 2, or the difference is smaller than a predetermined value (or smaller than a predetermined ratio), the two videos may be displayed in descending order of the number of comments on the video, which is the priority order 3.

In addition, in a case where the predetermined information is the reproduction period of time of the video, a plurality of pieces of video information are presented in ascending order. This is because in a case where the length of the video is too long, there is a high possibility that it takes time for the user to browse and find desired information (for example, a spectacular location in the touring course). Further, it is considered that it is tedious to browse a too long video, and the reproduction of the video is often finished before its entirety is reproduced. For this reason, they are presented in ascending order of the reproduction period of time. Note that if the reproduction period of time of the video is too short, it is considered that the user cannot obtain desired information. Hence, videos shorter than a certain period of time may be excluded, and then the plurality of pieces of video information are presented in ascending order.

### One Example of Display Control of Video Information

In the above-described embodiment, an example has been described in which the video information related to the touring course included in the range of the map that is currently displayed in the map display area 501 is displayed in the video information display area 502.

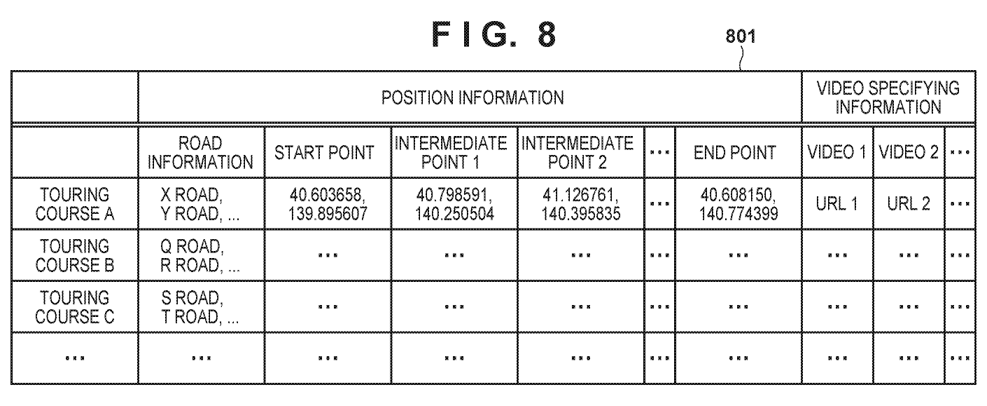

For example, the information processing apparatus 10 is capable of holding, as table information 801 as illustrated in FIG. 8, the position information of the touring course and the specifying information for specifying the video of the touring course in association with each other. For example, information such as an X road, a Y road, and so on is held as road information of the touring course A. In addition, by setting a start point, an intermediate point 1, an intermediate point 2,..., and an end point of the touring course A, information of latitude and longitude of each point is held. Further, information such as a URL 1 of a video 1, a URL 2 of a video 2, and so on is held as the video specifying information related to the touring course A. The same information of the other touring courses B, C, and so on is also held. The information processing apparatus 10 is capable of holding these pieces of information of all of the nationwide touring courses.

Here, it may be configured in such a manner that, among the touring courses displayed in the map display area 501, the video information related to a touring course having a start point and an end point both included in the map display area 501 is displayed. Thus, only the video information related to the touring course estimated that the entire touring course is substantially included in the map display area 501 is extracted. Therefore, it becomes possible to suppress the display of the video information related to the touring course only a small portion of which is included in the map. Therefore, touring course video information not intended by the user is less likely to be displayed, and access to the desired video information is facilitated.

Alternatively, it may be configured to display video information related to a touring course at least partially included in the map display area 501. Here, each touring course may include information of a plurality of points including a start point, one or more intermediate points, and an end point. As an example, an intermediate point may be set every 5 km or 10 km. Then, in a case where two or more of these points are included, it may be determined that the touring course is at least partially included in the map display area 501.

The touring course at least partially included in the map display area 501 may mean that a predetermined number or more of pairs including one or more adjacent points are included in the map display area 501. The pair of adjacent points denote, for example, i) a pair of a start point and an intermediate point adjacent to the start point, ii) a pair of two adjacent intermediate points, or iii) a pair of an end point or an intermediate point adjacent to the end point. This facilitates display of the video information of the touring course intended by the user, and facilitates access to the desired video information.

As described heretofore, in the present embodiment, the map including the touring course is displayed, based on the position information related to the touring course, and the video information related to the touring course that is currently displayed on the map is also displayed. When the user operates the map to move, enlarge, and/or shrink the display position of the map, and changes the display range of the map, the display of the video information related to the touring course in the map is also changed accordingly. Thus, by browsing the video, the user is able to easily confirm the details of the touring course. Therefore, it becomes possible to easily select a course along which the user desires to go touring. In the past, when finding a place of interest introduced in a video, it used to be necessary to search a map by yourself. However, the present invention has a function of associating a position with a video beforehand, so that a viewer can easily search a map for a place of the video or its periphery. In addition, in reverse usage, it is also possible to find a new video from the map. As a viewpoint of a video content creator, in describing places introduced in the video to viewers, it used to be necessary to display a map in describing the places in the video so far. However, according to the present invention, it becomes possible to link the video with the map, so that the content that allows a viewer to dynamically associate the position with the video can be provided.

### Modification of First Embodiment

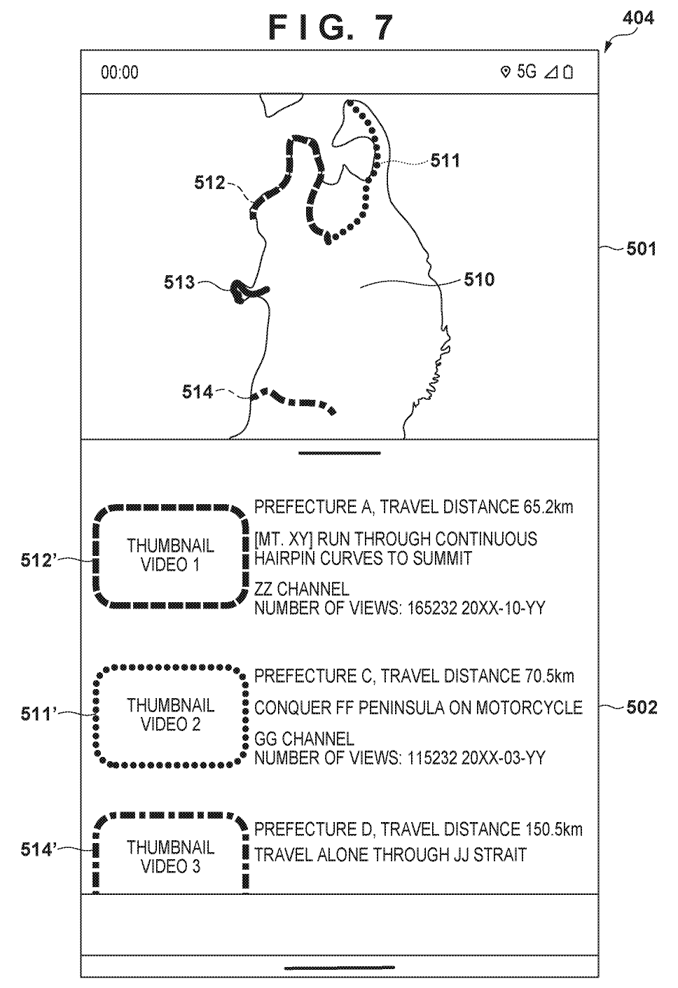

FIG. 7 is a diagram illustrating a modification of the display example illustrated in FIG. 5. In the display example of FIG. 7, control is conducted in such a manner that the periphery of each thumbnail video is surrounded by a thick frame, and the line type of each frame is displayed with the same line type as the line type of the touring course.

In FIG. 7, a thumbnail video 1 is surrounded by a frame 512', and the line type of the frame 512' is the same as the display line type of the touring course 512. Similarly, a thumbnail video 2 is surrounded by a frame 511', and the line type of the frame 511' is the same as the display line type of the touring course 511. Furthermore, a thumbnail video 3 is surrounded by a frame 514', and the line type of the frame 514' is the same as the display line type of the touring course 514. This enables the user to easily recognize that each piece of video information corresponds to the video information of which touring course.

In addition, in the present embodiment, as illustrated in FIG. 5, an example has been described in which the respective touring courses 511 to 514 are displayed in different line types, colors, or patterns. However, there is no intention of being limited to this example. For example, the color display of each touring course may have a meaning. For example, a touring course with good scenery may be displayed in “blue”, and a touring course that is enjoyable in traveling may be displayed in “green”. Furthermore, a touring course suitable for the autumn leaves season may be displayed in “red”, an off-road touring course may be displayed in “brown”, and a touring course for gourmet food may be displayed in “yellow”. Thus, by only looking at the color of the displayed touring course, the user is able to promptly recognize what kind of touring course it is. For example, in searching for a touring course suitable for the autumn leaves season, it is sufficient to focus on the touring course indicated in red, and thus it becomes possible to find a desired touring course promptly.

In addition, a function of filtering the touring courses may be provided. For example, it may be controlled in such a manner that the touring courses displayed in the map display area can be narrowed down for every video content creator (or for every channel name), that is, for every influencer. For example, in response to receipt of the user selection of an influencer, filtering may be conducted to display only the touring courses the videos of which have been posted by the selected influencer. In addition, in response to receipt of one or more pieces of designation from among, for example, “a touring course with good scenery”, “a touring course that is enjoyable in traveling”, “a touring course suitable for the autumn leaves season”, “an off-road touring course”, “a touring course for gourmet food”, and the like, filtering may be conducted to display only the touring course of a designated theme.

Thus, it becomes possible to narrow down the touring courses to be displayed. Therefore, also in a case where pieces of information of a large number of touring courses are provided via the touring information presentation application, it becomes possible to easily search for a desired touring course.

### Second Embodiment

In the present embodiment, another example of enabling a user of a straddle type vehicle such as a motorcycle to efficiently search for, confirm, and select a touring course will be described.

Since a system configuration and an apparatus/device configuration are similar to those in the first embodiment, detailed descriptions will be omitted.

### Processing Sequence

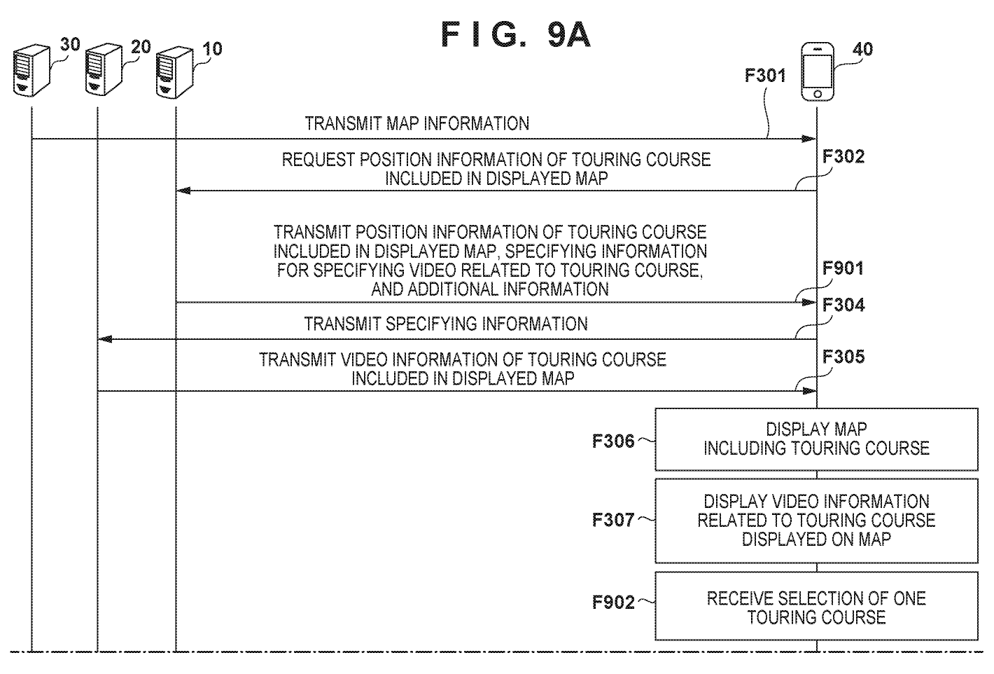

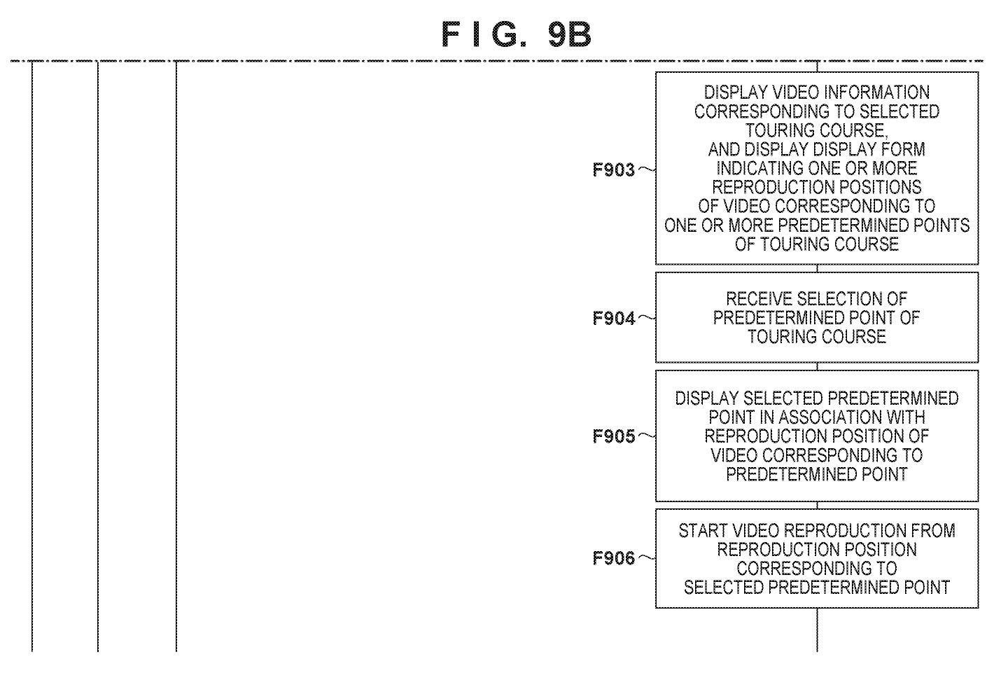

FIGS. 9A and 9B are diagrams each illustrating an example of a processing sequence in the information processing system according to the present embodiment. Such a processing sequence is performed, for example, when the user of the communication device 40 starts the touring information presentation application. The processing steps in F301, F302, and F304 through F307 are respectively similar to the processing steps of the same reference numerals in FIGS. 3A and 3B, and thus their descriptions will be omitted.

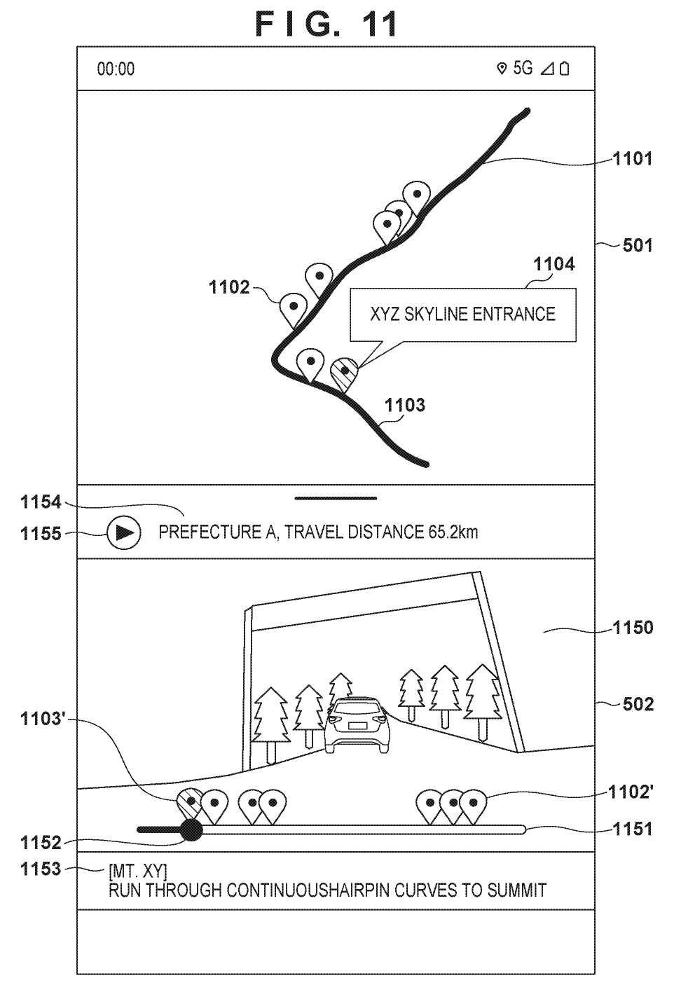

In F901, in response to a request from the communication device 40, the information processing apparatus 10 transmits, to the communication device 40, the position information of the touring course included in the currently displayed map, the specifying information for specifying the video (for example, a URL or the like of the video) related to the touring course, and additional information. Unlike the first embodiment, in the present embodiment, the additional information is further transmitted. Here, the additional information includes information indicating one or more predetermined points of each touring course on the map, and information indicating a reproduction position of a video of the touring course, the reproduction position corresponding to each of the one or more predetermined points. It is assumed that the operator of the information processing apparatus 10 manually associates the predetermined point of the touring course with the reproduction position of the video beforehand. Thus, it becomes possible to display predetermined points on the touring course to be described later with reference to FIG. 11 and the like in association with video reproduction positions respectively corresponding to them, and to reproduce the video from each video reproduction position.

Before the processing step of F902 is started, for example, the map display area 501 and the video information display area 502 as illustrated in FIG. 5 are displayed.

In F902, the communication device 40 receives user's selection of one touring course from among one or more touring courses displayed in the map display area 501 of the display unit 404. For example, the selection may be received by clicking or tapping one touring course.

In F903, the communication device 40 displays one selected touring course in the map display area 501, and also displays a display form indicating one or more predetermined points of the touring course, based on the additional information received in F901. In accordance with this, the entirety of one touring course that has been selected may be displayed in a size that fits within the map display area. Then, by using the additional information, a display form indicating one or more predetermined points (for example, spectacular location(s)) on the touring course is displayed on the touring course. Details of the display will be described later with reference to FIG. 11.

In F904, the communication device 40 receives selection of a predetermined point of the displayed touring course. For example, the selection may be received by clicking or tapping a display form indicating such a predetermined point.

In F905, the communication device 40 displays the selected predetermined point in association with the reproduction position of the video, the reproduction position corresponding to the predetermined point. Here, the communication device 40 displays a display form indicating the video reproduction position corresponding to the predetermined point, based on the additional information. Note that here, it is assumed that one video is prepared for one touring course, but a plurality of videos may be prepared for one touring course. In such a case, for example, a plurality of predetermined points related to the plurality of videos may be displayed in a mixed manner on one touring course. Then, in a case where one predetermined point of them is selected, it may be configured to display the video information corresponding to the selected predetermined point in the video information display area 502. Thus, in a case where one predetermined point related to a video A is selected, the video information of the video A related to such one predetermined point is displayed in the video display area 502. In addition, in a case where one predetermined point related to a video B is selected, the video information of the video B related to such one predetermined point is displayed in the video display area 502. Details of the display will be described later with reference to FIG. 11.

In F906, the communication device 40 starts video reproduction from the reproduction position corresponding to the predetermined point selected in F905.

### Processing of Communication Device

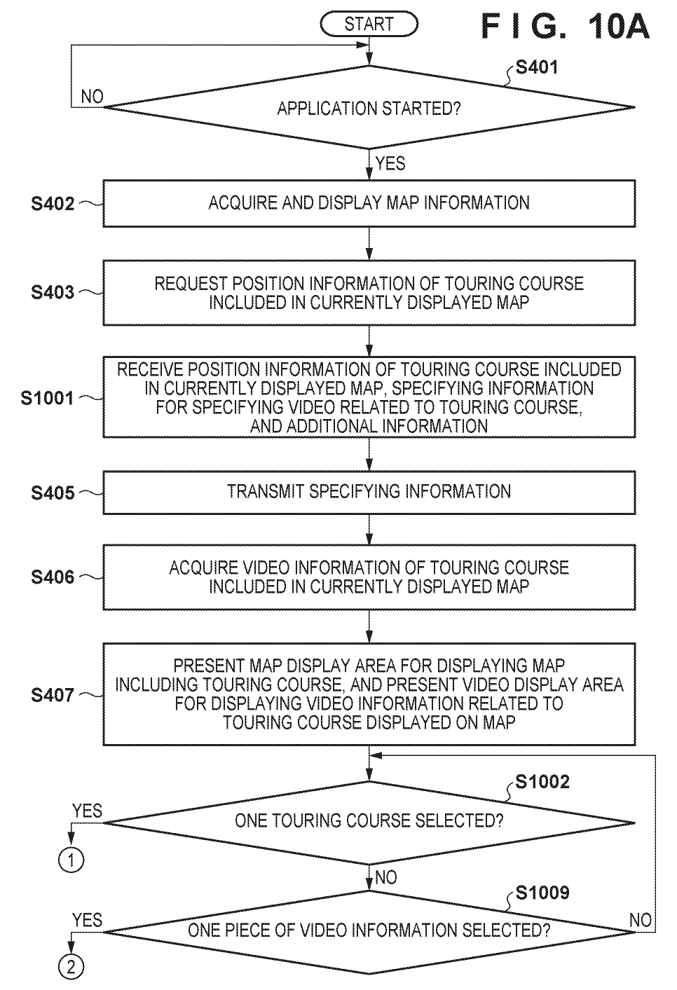

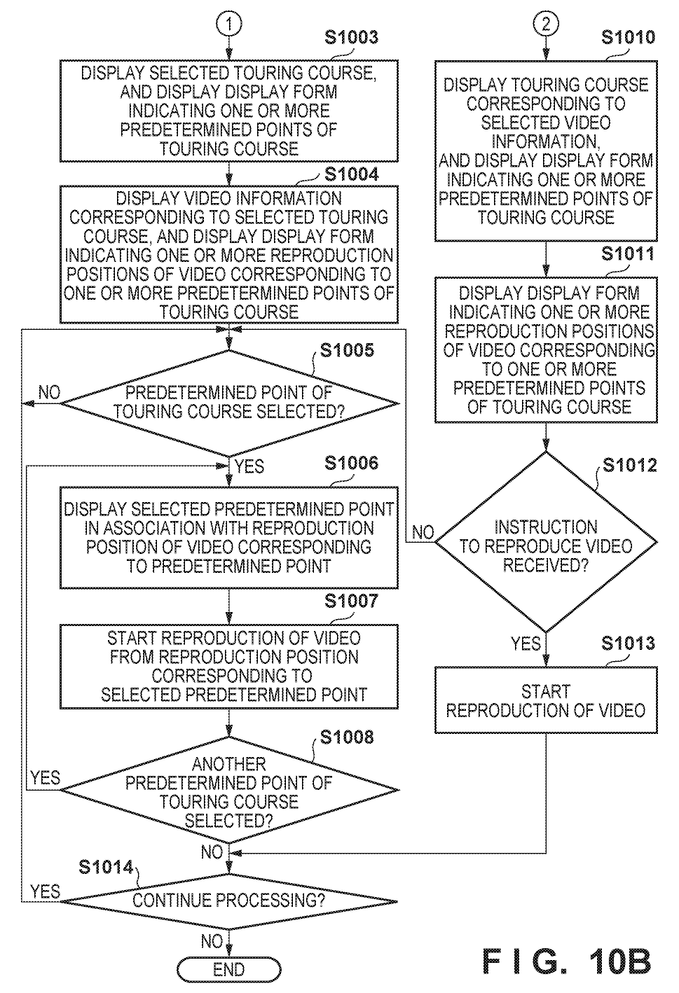

Subsequently, FIGS. 10A and 10B are flowcharts each illustrating a procedure of processing performed by the communication device 40 according to the present embodiment. The present processing is performed by the CPU 401 of the communication device 40 reading and executing a program stored in the storage device 402.

The processing steps S401 through S403 and S405 through S407 are respectively similar to the processing steps of the same reference numerals in FIG. 4, and thus their descriptions will be omitted.

In step S1001, the CPU 401 receives, from the information processing apparatus 10, the position information of the touring course included in the currently displayed map, the specifying information for specifying the video (for example, a URL or the like of the video) related to the touring course, and additional information. Unlike the first embodiment, in the present embodiment, the additional information is further received. Here, as described above, the additional information includes information indicating one or more predetermined points of each touring course on the map, and information indicating a reproduction position of a video of the touring course, the reproduction position corresponding to each of the one or more predetermined points. That is, the additional information includes information that associates a predetermined point of the touring course with the video reproduction position.

In step S1002, the CPU 401 determines whether one touring course has been selected by the user from among one or more touring courses displayed in the map display area 501 of the display unit 404. For example, the selection may be received by clicking or tapping one touring course. In a case where Yes is determined in the present step, the processing proceeds to step S1003. On the other hand, in a case where No is determined in the present step, the processing proceeds to step S1009.

In step S1003, the CPU 401 displays the selected touring course, and also displays a display form indicating one or more predetermined points of the touring course. Here, a display example on the display unit 404 of the communication device 40 according to the present embodiment will be described with reference to FIG. 11. One touring course 1101 is selected, and the display of the map is updated so that only the touring course 1101 is displayed in the map display area 501. Then, a display form 1102 indicating one or more predetermined points of the touring course 1101 is displayed, based on the additional information received in step S1001. A plurality of display forms 1102 are displayed in the illustrated example.

In step S1004, the CPU 401 displays the video information corresponding to the selected touring course, and also displays a display form indicating one or more reproduction positions of the video, the one or more reproduction positions corresponding to one or more predetermined points of the touring course. For example, as illustrated in FIG. 11, video information corresponding to the selected touring course 1101 is displayed in the video display area 502. Then, a display form 1102' indicating one or more reproduction positions of the video is displayed, the one or more reproduction positions corresponding to one or more predetermined points (the display form 1102) of the touring course 1101. Note that as described above, here, it is assumed that one video is prepared for one touring course, but a plurality of videos may be prepared for one touring course. In such a case, for example, a plurality of predetermined points related to the plurality of videos may be displayed in a mixed manner on one touring course. Then, in a case where one predetermined point of them is selected, it may be configured to display the video information corresponding to the selected predetermined point in the video information display area 502. Thus, in a case where one predetermined point related to the video A is selected, the video information of the video A related to such one predetermined point is displayed in the video display area 502. In a case where one predetermined point related to the video B is selected, the video information of the video B related to such one predetermined point is displayed in the video display area 502.

In step S1005, the CPU 401 determines whether one predetermined point of the plurality of predetermined points on the touring course has been selected. For example, the selection may be received by clicking or tapping a display form indicating such a predetermined point. In a case where Yes is determined in the present step, the processing proceeds to step S1006. On the other hand, in a case where No is determined in the present step, the processing waits until selection.

In the example of FIG. 11, it is assumed that one predetermined point (a display form 1103) of the plurality of predetermined points (the display form 1102) is selected. The selected predetermined point (the display form 1103) is displayed in a color and/or a pattern different from those of the other predetermined points (the display form 1102), and it is possible to easily recognize that the point is selected. Furthermore, detailed information 1104 (in the illustrated example, text indicating that the point is the “XYZ skyline entrance”) of the selected predetermined point (the display form 1103) may be displayed.

In step S1006, the CPU 401 displays the selected predetermined point in association with the reproduction position of the video, the selected predetermined point corresponding to the reproduction position.

As illustrated in FIG. 11, the selected predetermined point (the display form 1103) is displayed in a color and/or pattern different from those of the other predetermined points. Furthermore, the reproduction position (a display form 1103') of the video is displayed in the same color and/or pattern as that of the predetermined point (the display form 1103), the reproduction position (the display form 1103') corresponding to the predetermined point (the display form 1103). A current reproduction point 1152 on a reproduction bar 1151 indicating the entire video, a title 1153 of the video, and reference information 1154 indicating the prefecture where the touring course in the video is located and the travel distance of the touring course are also displayed. In addition, a thumbnail image 1150 of the video is displayed. This corresponds to a thumbnail image at the reproduction position (the display form 1103') of the video, the reproduction position (the display form 1103') corresponding to the predetermined point (the display form 1103) (the XYZ skyline entrance).

In step S1007, the CPU 401 starts reproduction of the video from the reproduction position corresponding to the selected predetermined point. In the present processing, the processing of step S1005 ends, and after a lapse of a predetermined time, the reproduction of the video may be automatically started from the reproduction position (the display form 1103'). Alternatively, it is possible to start the reproduction of the video from the reproduction position (the display form 1103') by clicking or tapping a play button 1155 as illustrated in FIG. 11.

In step S1008, the CPU 401 determines whether another predetermined point of the plurality of predetermined points on the touring course has been selected. In a case where Yes is determined in the present step, the processing returns to step S1006. On the other hand, in a case where No is determined in the present step, the processing proceeds to step S1014.

In step S1009, the CPU 401 determines whether one piece of video information is selected by the user from one or more pieces of video information displayed in the video information display area 502. In a case where Yes is determined in the present step, the processing proceeds to step S1010. On the other hand, in a case where No is determined in the present step, the processing returns to step S1002.

In step S1010, the CPU 401 displays the touring course corresponding to the selected video information, and also displays a display form indicating one or more predetermined points of the touring course. In accordance with selection of one piece of video information from the plurality of pieces of video information as illustrated in FIG. 5, the corresponding touring course is selected, and the display position is automatically changed (moved, enlarged, and/or shrunk) and displayed as in the map display area 501 of FIG. 11. Then, the display form 1102 indicating one or more predetermined points is also displayed.

In step S1011, the CPU 401 displays a display form indicating one or more reproduction positions of the video, the one or more reproduction positions corresponding to one or more predetermined points of the touring course. As illustrated in FIG. 11, the display form 1102' indicating one or more reproduction positions of the video is displayed in the video display area 502, the one or more reproduction positions corresponding to one or more predetermined points (the display form 1102) of the touring course 1101.

In step S1012, the CPU 401 determines whether an instruction to reproduce the video has been received from the user. In a case where Yes is determined in the present step, the processing proceeds to step S1013. On the other hand, in a case where No is determined in the present step, the processing returns to step S1005.

In step S1013, the CPU 401 starts reproduction of the video. Then, the processing proceeds to step S1014.

In step S1014, the CPU 401 determines whether to continue the series of processing steps. For example, when the user ends the touring information presentation application, the processing ends. In a case where Yes is determined in the present step, the processing returns to S1005. On the other hand, in a case where No is determined in the present step, the processing ends.

Note that in FIGS. 10A and 10B, the description has been made with regard to processing including not only display control in response to the selection of the touring course as also illustrated in FIGS. 9A and 9B but also display control in response to the selection of the video information.

As described heretofore, in the present embodiment, in response to the user selecting one of the one or more touring courses displayed on the map, the display is updated to include only such one touring course in the map display area, and also to display the display form indicating the one or more predetermined points on the touring course. In addition, the video information corresponding to the selected touring course is displayed in the video information display area, and the display form indicating one or more reproduction positions of the video is also displayed, the one or more reproduction positions corresponding to one or more predetermined points. Then, in response to the user selecting one predetermined point, such one predetermined point is displayed in a highlighted manner, and the corresponding reproduction position on the video is similarly displayed in a highlighted manner. In this state, by instructing the reproduction start of the video, it becomes possible to reproduce and browse the video from the reproduction position corresponding to the selected predetermined point of the touring course. Alternatively, after a predetermined time elapses since the display is made in the highlighted manner, it is possible to automatically reproduce and browse the video.

This enables the user to easily confirm the details of the touring course in a simple operation of selecting the touring course. Therefore, it becomes possible to easily select a course along which the user desires to go touring.

In addition, in the present embodiment, in response to the user selecting one of the plurality of pieces of video information, the display is updated to include only the touring course corresponding to such video information in the map display area, and also to display a display form indicating one or more predetermined points on the touring course. Then, the display form indicating one or more reproduction positions of the video is displayed, the one or more reproduction positions corresponding to one or more predetermined points.

This enables the user to easily confirm the details of the touring course in a simple operation of selecting the video information. Therefore, it becomes possible to easily select a course along which the user desires to go touring.

In this manner, in the present embodiment, the map including the touring course is displayed, and the display form indicating one or more predetermined points of the touring course is also displayed. Then, the video information corresponding to the touring course is displayed, and the display form indicating one or more reproduction positions of the video is also displayed, the one or more reproduction positions corresponding to the one or more predetermined points.

Thus, it becomes possible to easily recognize the correspondence relationship between a point on the touring course and the video reproduction position corresponding to such a point. Therefore, it becomes possible to easily grasp which point of the video is to be reproduced by reproducing at which position of the video. Therefore, the user is able to easily confirm the details of the touring course. In the past, when finding a place of interest introduced in a video, it used to be necessary to search a map by yourself. However, the present invention has a function of associating a position with a video beforehand, so that a viewer can easily search a map for a place of the video or its periphery. In addition, in reverse usage, it is also possible to find a new video from the map. As a viewpoint of a video content creator, in describing places introduced in the video to viewers, it used to be necessary to display a map in describing the places in the video so far. However, according to the present invention, it becomes possible to link the video with the map, so that the content that allows a viewer to dynamically associate the position with the video can be provided.

### Modification of Second Embodiment

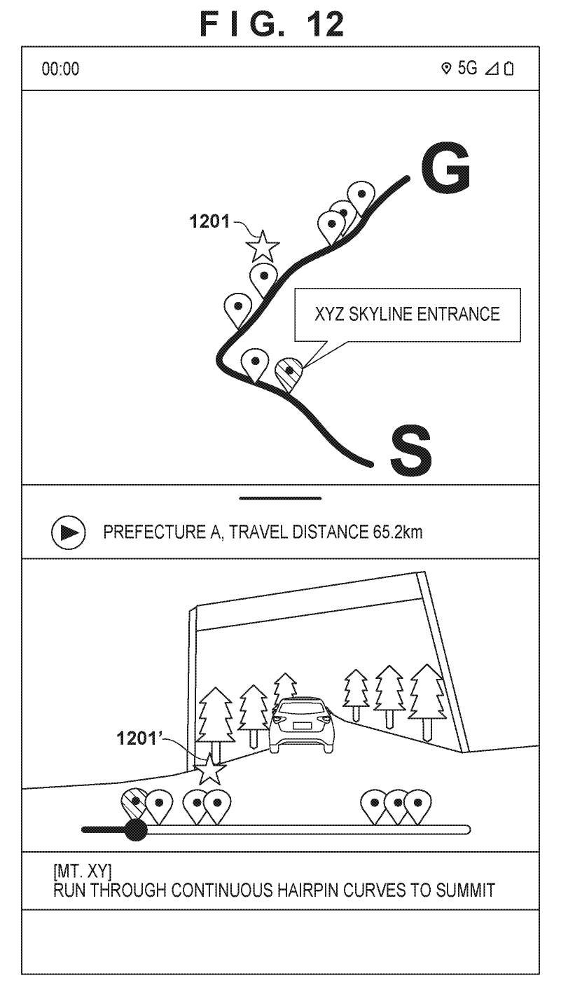

FIG. 12 is a diagram illustrating a modification of the display example illustrated in FIG. 11. The display example of FIG. 12 is substantially similar to the display example of FIG. 11. However, a display form (S) indicating a start position of the touring course 1101 and a display form (G) indicating a goal position of the touring course 1101 are further displayed in the map display area 501.

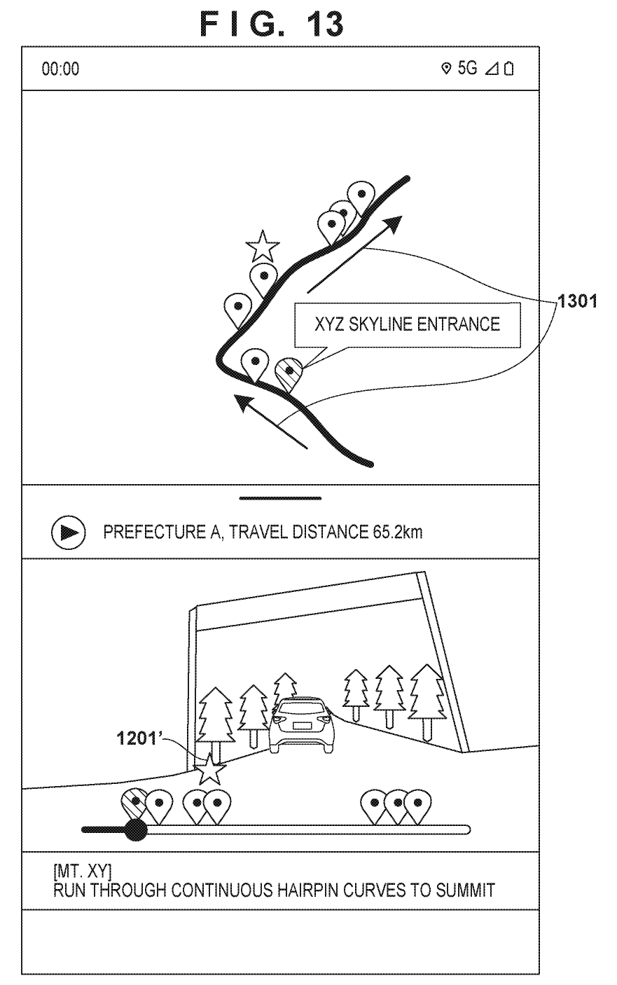

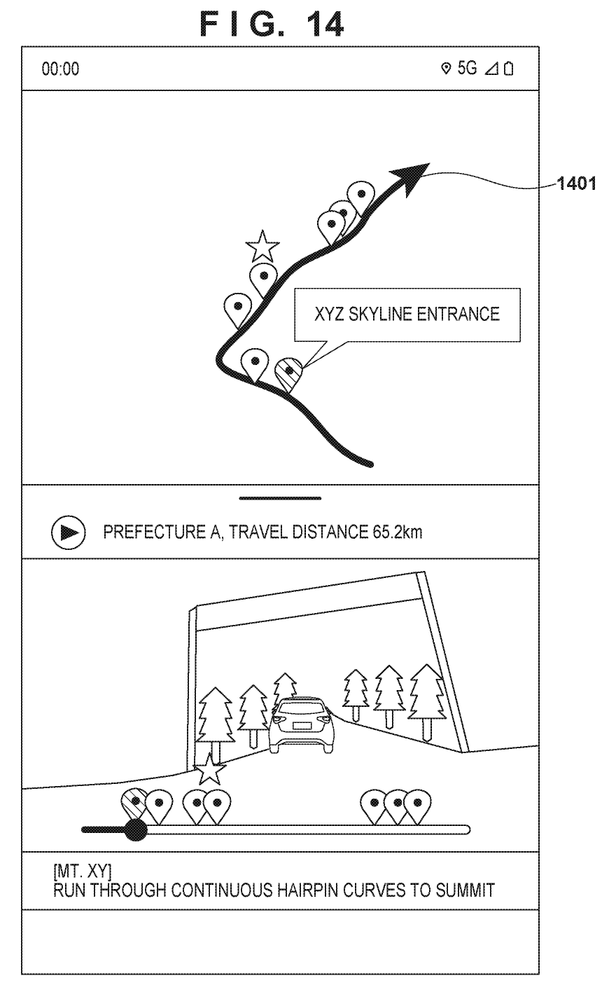

According to the display in this manner, with regard to the displayed touring course, the user is able to easily recognize in which advancing direction the video has been recorded. Note that the display form is not limited to the display form of S or G, and any other display form may be applicable. For example, as illustrated in FIG. 13, one or more arrows 1301 along the touring course (arrows indicating the advancing direction of the course video) may be added to be adjacent to the touring course. Alternatively, as illustrated in FIG. 14, an arrow head 1401 may be provided at an end portion of the touring course. Any display form may be applicable as long as the advancing direction of the touring course in the video is recognizable.

In addition, as illustrated in FIG. 12, a display form 1201 (a star mark in the illustrated example) indicating an emphasis point may be displayed in the map display area 501. Further, a display form 1201' indicating a video reproduction position corresponding to the emphasis point may be further displayed in the video information display area 502. Here, the emphasis point is an interesting point with a scenic and attractive location in the touring course, and only one emphasis point may be arranged for one touring course and the video corresponding to such one touring course. Thus, the user only needs to confirm the course by particularly focusing on the emphasis point of each touring course. Thus, it becomes possible to efficiently confirm each touring course.

In addition, in the second embodiment, the descriptions of the map operations as illustrated in F308 through F315 in FIGS. 3A and 3B and S410 in FIG. 4 in the first embodiment and the update of the screen display in response to the map operation have been omitted. However, processing similar to that in the first embodiment may be performed.

Further, in each of the above-described embodiments, an example has been described in which the information processing apparatus 30 provides the communication device 40 with the map information, the information processing apparatus 20 provides the communication device 40 with video(s), and the information processing apparatus 10 provides the communication device 40 with information necessary for the display on the communication device 40. However, there is no intention of being limited to this example. For example, the information processing apparatus 10 may also manage the map information and the video(s), and the map information and the video(s) may be configured to be provided from the information processing apparatus 10 for the communication device 40. Furthermore, the map information may be held beforehand by the communication device 40, and the map information that is held may be used.

In addition, in each of the above-described embodiments, an example has been described in which various types of information are aggregated in the communication device 40, and the communication device 40 displays the touring course and the video information. However, there is no intention of being limited to this example. For example, the information processing apparatus 10 may acquire or hold various types of information beforehand, and may be configured to control and display the touring course and the video on the display unit 404 of the communication device 40. In such a case, the information processing apparatus 10 may collectively manage some or all pieces of the map information, the position information of the touring course, the specifying information for specifying the video, the video information, and the video data itself. Alternatively, the map information may be acquired from the information processing apparatus 30, and the video information (and the video data) may be acquired from the information processing apparatus 20.

For example, the operation information (information of the displayed map range) may be transmitted to the information processing apparatus 10 in response to the user performing an operation of moving, enlarging, and/or shrinking the map on the communication device 40. The information processing apparatus 10 may transmit the information of the touring course within the map range to the communication device 40, based on the information of the displayed map range, and may cause the communication device 40 to display the information. Then, the video information related to the touring course may be acquired from the information processing apparatus 20, and may be transmitted to the communication device 40 to be displayed. Thus, the information processing apparatus 10 is capable of performing the processing contents that have been performed by the communication device 40 in each of the above-described embodiments.

### SUMMARY OF EMBODIMENTS

1. The communication device (40) according to the above embodiments is a communication device comprising

control means for displaying a map including a touring course (1101), and also displaying a display form indicating one or more predetermined points (1102) of the touring course, and

displaying video information corresponding to the touring course, and also displaying a display form indicating one or more reproduction positions of a video, the one or more reproduction positions corresponding to the one or more predetermined points.

According to this embodiment, it becomes possible to easily recognize the correspondence relationship between the point on the touring course and the video reproduction position corresponding to the point. Therefore, it becomes possible to easily grasp which point of the video is to be reproduced by reproducing at which position of the video. Therefore, the user is able to easily confirm the details of the touring course.

2. The communication device (40) according to the above embodiments further comprising

point selection means for receiving selection of one predetermined point from the one or more predetermined points, wherein

when the point selection means receives the selection of the one predetermined point, the control means displays the one predetermined point in association with one video reproduction position corresponding to the one predetermined point in a highlighted manner (1103, 1103’).

According to this embodiment, it becomes possible to easily recognize the correspondence relationship between the point of the touring course on which the user focuses and the video reproduction position corresponding to the point.

3. The communication device (40) according to the above embodiments, wherein after a predetermined time elapses since displaying in the highlighted manner, the control means starts reproduction of a video from the one video reproduction position corresponding to the one predetermined point

According to this embodiment, after recognizing the correspondence relationship between the point on the touring course and the video reproduction position of the point, the user is able to promptly browse the video of the point.

4. The communication device (40) according to the above embodiments, wherein when the point selection means receives the selection of the one predetermined point, the control means displays a thumbnail (1150) of a video at the one video reproduction position corresponding to the one predetermined point.

According to this embodiment, by looking at the thumbnail, it is easy to determine whether to actually reproduce and confirm the video of the point.

5. The communication device (40) according to the above embodiments, wherein the control means further displays, on the map, a display form (S, G, arrow) indicating an advancing direction of the touring course in accordance with reproduction of the video.

According to this embodiment, it becomes possible to easily grasp which direction of the touring course on the map the advancing direction in touring in the video corresponds to.

6. The communication device (40) according to the above embodiments, wherein the control means displays a start position (S) and a goal position (G) of the touring course on the map to indicate the advancing direction (FIG. 12).

According to this embodiment, it becomes possible to easily grasp which direction of the touring course on the map the advancing direction in touring in the video corresponds to.

7. The communication device (40) according to the above embodiments, wherein the control means displays one or more arrows indicating the advancing direction on the map (FIGS. 13, 14).

According to this embodiment, it becomes possible to easily grasp which direction of the touring course on the map the advancing direction in touring in the video corresponds to.

8. The communication device (40) according to the above embodiments, wherein the control means further displays a display form (1201) indicating an emphasis point that is a scenic location in the touring course out of the one or more predetermined points, and also displays a display form (1201’) indicating a video reproduction position corresponding to the emphasis point.

According to this embodiment, even in a case where a plurality of points are displayed on the touring course, it becomes possible to recognize a scenic location of the touring course by confirming the video of the emphasis point, so that useful information can be grasped promptly when unsure about determining which point of the video should be displayed.

9. The communication device according to the above embodiments, wherein the control means displays the display form indicating the one or more predetermined points on the touring course (FIG. 11).

According to this embodiment, it becomes possible to recognize at a glance where on the touring course the predetermined point is present.

10. The communication device (40) according to the above embodiments, wherein

the control means displays a reproduction bar (1151) of a video corresponding to the touring course, and

the control means displays a display form (1102’) indicating the one or more reproduction positions along the reproduction bar.

According to this embodiment, it becomes possible to easily recognize from which reproduction position in the reproduction period of time of one entire video it is possible to reproduce the video.

11. The communication device (40) according to the above embodiments, wherein the control means displays the map including the touring course in a map display area (501), and also displays the video information in a video information display area (502).

According to this embodiment, by displaying different pieces of information in different display areas, it becomes possible to simultaneously operate the map and confirm the video information. In addition, by using different display areas, the visibility is improved, so that the convenience of the user can be improved.

12. The information processing apparatus (10) according to the above embodiments is an information processing apparatus that communicates with a communication device (40), the information processing apparatus comprising

control means (101) for causing display means (404) of the communication device to display a map including a touring course, and also to display a display form indicating one or more predetermined points of the touring course, and

causing the display means of the communication device to display video information corresponding to the touring course, and also to display a display form indicating one or more reproduction positions of a video, the one or more reproduction positions corresponding to the one or more predetermined points.

According to this embodiment, it becomes possible to easily recognize the correspondence relationship between the point on the touring course and the video reproduction position corresponding to the point. Therefore, it becomes possible to easily grasp which point of the video is to be reproduced by reproducing at which position of the video. Therefore, the user is able to easily confirm the details of the touring course.

13. The control method of a communication device (40) according to the above embodiments is a control method of a communication device, the control method comprising

a control step of displaying a map including a touring course, and also displaying a display form indicating one or more predetermined points of the touring course, and

displaying video information corresponding to the touring course, and also displaying a display form indicating one or more reproduction positions of a video, the one or more reproduction positions corresponding to the one or more predetermined points (FIG. 11).

According to this embodiment, it becomes possible to easily recognize the correspondence relationship between the point on the touring course and the video reproduction position corresponding to the point. Therefore, it becomes possible to easily grasp which point of the video is to be reproduced by reproducing at which position of the video. Therefore, the user is able to easily confirm the details of the touring course.

14. The control method of an information processing apparatus (10) according to the above embodiments is a control method of an information processing apparatus that communicates with a communication device (40), the control method comprising

a control step of causing display means (404) of the communication device to display a map including a touring course, and also displaying a display form indicating one or more predetermined points of the touring course, and

causing the display means of the communication device to display video information corresponding to the touring course, and also to display a display form indicating one or more reproduction positions of a video, the one or more reproduction positions corresponding to the one or more predetermined points (FIG. 11).

According to this embodiment, it becomes possible to easily recognize the correspondence relationship between the point on the touring course and the video reproduction position corresponding to the point. Therefore, it becomes possible to easily grasp which point of the video is to be reproduced by reproducing at which position of the video. Therefore, the user is able to easily confirm the details of the touring course.

15. The program according to the above embodiments is a program for causing a computer to execute the control method according to the above embodiments.

According to this embodiment, the control method according to the above embodiment is achievable as a program.

15. The storage medium according to the above embodiments is a storage medium storing a program for causing a computer to execute the control method according to the above embodiments.

According to this embodiment, the control method according to the above embodiment is achievable as a storage medium.

According to the present invention, a user is able to easily confirm details of a touring course. In addition, the user is able to easily confirm a video linked with a position on the touring course, and is able to confirm beforehand atmosphere of places, road surface conditions of roads, and the like that cannot be conveyed only by still images or texts.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A communication device, comprising
a control unit configured to display a map including a touring course, and also display a display form indicating one or more predetermined points of the touring course, and
display video information corresponding to the touring course, and also display a display form indicating one or more reproduction positions of a video, the one or more reproduction positions corresponding to the one or more predetermined points.

2. The communication device according to claim 1, further comprising
a point selection unit configured to receive selection of one predetermined point from the one or more predetermined points, wherein
when the point selection unit receives the selection of the one predetermined point, the control unit displays the one predetermined point in association with one video reproduction position corresponding to the one predetermined point in a highlighted manner.

3. The communication device according to claim 2, wherein after a predetermined time elapses since displaying in the highlighted manner, the control unit starts reproduction of a video from the one video reproduction position corresponding to the one predetermined point.

4. The communication device according to claim 2, wherein when the point selection unit receives the selection of the one predetermined point, the control unit displays a thumbnail of a video at the one video reproduction position corresponding to the one predetermined point.

5. The communication device according to claim 1, wherein the control unit further displays, on the map, a display form indicating an advancing direction of the touring course in accordance with reproduction of the video.

6. The communication device according to claim 5, wherein the control unit displays a start position and a goal position of the touring course on the map to indicate the advancing direction.

7. The communication device according to claim 5, wherein the control unit displays one or more arrows indicating the advancing direction on the map.

8. The communication device according to claim 1, wherein the control unit further displays a display form indicating an emphasis point that is a scenic location in the touring course out of the one or more predetermined points, and also displays a display form indicating a video reproduction position corresponding to the emphasis point.

9. The communication device according to claim 1, wherein the control unit displays the display form indicating the one or more predetermined points on the touring course.

10. The communication device according to claim 1, wherein
the control unit displays a reproduction bar of a video corresponding to the touring course, and
the control unit displays a display form indicating the one or more reproduction positions along the reproduction bar.

11. The communication device according to claim 1, wherein the control unit displays the map including the touring course in a map display area, and also displays the video information in a video information display area.

12. An information processing apparatus that communicates with a communication device, the information processing apparatus comprising
a control unit for causing a display unit of the communication device to display a map including a touring course, and also to display a display form indicating one or more predetermined points of the touring course, and
causing the display unit of the communication device to display video information corresponding to the touring course, and also to display a display form indicating one or more reproduction positions of a video, the one or more reproduction positions corresponding to the one or more predetermined points.

13. A control method of a communication device, the control method comprising
displaying a map including a touring course, and also displaying a display form indicating one or more predetermined points of the touring course, and
displaying video information corresponding to the touring course, and also displaying a display form indicating one or more reproduction positions of a video, the one or more reproduction positions corresponding to the one or more predetermined points.

14. A control method of an information processing apparatus that communicates with a communication device, the control method comprising
causing a display unit of the communication device to display a map including a touring course, and also displaying a display form indicating one or more predetermined points of the touring course, and
causing the display unit of the communication device to display video information corresponding to the touring course, and also to display a display form indicating one or more reproduction positions of a video, the one or more reproduction positions corresponding to the one or more predetermined points.

15. A storage medium storing a program for causing a computer to execute a control method of a communication device, the control method comprising
displaying a map including a touring course, and also displaying a display form indicating one or more predetermined points of the touring course, and
displaying video information corresponding to the touring course, and also displaying a display form indicating one or more reproduction positions of a video, the one or more reproduction positions corresponding to the one or more predetermined points.

16. A storage medium storing a program for causing a computer to execute a control method of an information processing apparatus that communicates with a communication device, the control method comprising
causing a display unit of the communication device to display a map including a touring course, and also displaying a display form indicating one or more predetermined points of the touring course, and
causing the display unit of the communication device to display video information corresponding to the touring course, and also to display a display
form indicating one or more reproduction positions of a video, the one or more reproduction positions corresponding to the one or more predetermined points.
